(19) United States
(12) Patent Application Publication
(10) Pub. No.: US 2016/0282142 A1
(43) Pub. Date: Sep. 29, 2016

(54) MEASURING DEVICE AND METHOD FOR MEASURING THE POSITION OF BODIES

(71) Applicant: BOGEN ELECTRONIC GMBH, Berlin (DE)

(72) Inventors: Torsten Becker, Berlin (DE); Joern Hoyer, Grossbeeren (DE)

(73) Assignee: BOGEN ELECTRONIC GMBH, Berlin (DE)

(21) Appl. No.: 14/915,802

(22) PCT Filed: Aug. 13, 2014
(86) PCT No.: PCT/EP2014/067356

§ 371 Date: Mar. 1, 2016

(30) Foreign Application Priority Data
Sep. 4, 2013 (EP) 13183033.3

(51) Int. Cl. G01D 5/14

(52) U.S. Cl. CPC G01D 5/14

(57) ABSTRACT

A measuring device for measuring the position of a first body to a second body comprises a scale band that can be attached to the first body and that comprises a marker, wherein the measuring device comprises two marker detection sensors that can be attached to the second body, wherein the marker is formed by a pattern out of marker stripes, which transitions between a first position of the scale band and a second position are respectively arranged predetermined inclined to the transversal direction of the scale band in such a respective inclination angle that each of the inclination angles has a value that differs from the values of the other inclination angles.

The invention relates to a measuring device and a method for measuring the positions of a first body to a second body being neighboured to the first body and being movable relative to the first body.

It is known in machine tool manufacturing to use, for example, a magnetic linear scale for the determination of a position of a tool slide. The positions can be determined by a relative measurement or an absolute measurement. For the relative position determination, an indistinguishable bit pattern of alternating equally long north and south poles is measured. Since the single bits are not distinguishable, the positions are only relatively distinguishable and the position is generally generated by counting of the passed bits. For the absolute position determination, either the bit pattern is indicated by a second trace or a distinguishable bit pattern is used. In the first case, the single bits are indicated by a further trace and are therefore made distinguishable. In the second case, distinguishable bit patterns are for example used, in which the single scale increments are differently wide, for example they enlarge from an absolute start point. However, it is obligatory required that the respective widths of the scale increments are present only once, so that the recognition of the absolute position is unambiguous. However, the maximum measuring distance is hereby disadvantageously limited by the possibility to measure the local length of the single widths and to assign to its absolute position.

It is an object of the invention to provide a measuring device and a method for measuring the position of a first body to a second body being neighboured to the first body and being movable relative to the first body, wherein the distance range, in which its position can be, is large.

The object is solved with the features of the independent patent claims. Preferred embodiments thereto are given in the further patent claims.

The measuring device according to the invention for measuring the position of a first body to a second body being neighboured to the first body and being movable relative to the first body comprises a scale band that can be attached to the first body and that comprises a marker, wherein the measuring device comprises two marker detection sensors that can be attached to the second body, wherein the marker is formed by a pattern out of marker stripes, which transitions from marker stripe to marker stripe between a first position of the scale band and a second position being arranged in the longitudinal direction of the scale band in a distance to the first position are respectively arranged predetermined inclined to the transversal direction in such a respective inclination angle that each of the inclination angles has a value that differs from the values of the other inclination angles, wherein the scale band is divided in transversal direction into two traces, wherein one of the marker detection sensors is arranged neighboured to the first trace and the other of the marker detection sensors is arranged neighboured to the second trace as well as the marker detection sensors are arranged seen in the transversal direction of the scale band next to each other between the first position and the second position, so that the position of the first body to the second body can be determined within the first and the second position by detecting the inclination angles.

Since the both traces are arranged lying next to each other, the marker detection sensors are advantageously also arranged next to each other in the transversal direction of the scale band, whereby the complete range between the first position and the second position can be captured by the marker detection sensors. Therefore, the position of the first body to the second body can be on an arbitrary location between the first position and the second position. For example a displacement of the marker detection sensors in longitudinal direction of the scale band does not need to be provided, wherein the displacement would disadvantageously lead to a shortening of the measuring distance between the first position and the second position.

The marker stripes transitions extend free of steps from the first trace to the second trace, wherein they can be unambiguously assigned locally by their inclination angles. An exact determination of the position of the both bodies to each other within the measuring distance defined by the first position and the second position is therefore advantageously achieved by the measurement device according to the invention.

The scale band is preferably divided into the first trace on this side of its centre and into the second trace on the other side of its centre. The marker stripes are preferably formed in the shape of a trapezium. It is preferred for the pattern that it is alternating or it is generated by an arbitrary change of properties. It is preferred that the marker stripes are formed by colourings of the surface of the scale band and the marker detection sensors are optical sensors or cameras. It is hereby preferred that the marker stripes form a bright-dark-stripe pattern, for example a white-black-stripe pattern. It is alternatively preferred that the markers are formed by white-black-white-patterns. It is alternatively preferred that the marker stripes are formed by permanent magnetic poles of the scale band and that the marker detection sensors are magnetic sensors. It is hereby preferred that the magnetic sensors are magnetoresistive sensors or Hall-sensors.

The detected inclination angles are preferably processed during the determination of the position of the first body to the second body within the first and the second position such that a phase displacement or the polarity of the signals of the marker detection sensors are determined.

It is preferred that the marker stripe transitions on the first and the second position respectively have a minimum angle as their inclination angle as well as one of the marker stripe transitions is arranged between the both positions on a third position of the scale band, wherein this marker stripe transitions is arranged inclined in a maximum angle to the transversal direction of the scale band, wherein the inclination angles of the marker stripes transitions that are arranged between the first position and the third position and that are arranged between the second position and the third position increase in direction to the third position monotonically from the minimum angle to the maximum angle. It is hereby preferred that the marker stripes seen in the longitudinal direction of the scale band have respectively the same width in the centre of the scale band. It is further preferred that the minimum angle is 0°. The maximum angle is preferably 90°, in particular 60°.

The number of the marker stripe transitions from one of the marker stripes to the neighboured marker stripes between the first position and the third position and the number of the marker stripe transitions from one of the marker stripes to the neighboured marker stripe between the second position and the third position are preferably equally high. Furthermore, the inclination angles of the marker stripes that are arranged between the first position and the third position and that are arranged between the second position and the third position preferably increase strictly monotonically in direction to the third position from the minimum angle to the maximum angle.

If the scale band is preferably provided with the magnetic marker stripes, during the manufacturing of the scale band a writing tool is moved with constant translational velocity along the scale band during the magnetization and is thereby pivoted, for example, around the centre of the scale band, whereby the marker stripes lying next to each other and inclined to each as well as formed in the shape of a trapezium are formed. The polarity of the writing tool is thereby reversed in equal time intervals, so that the widths of the marker stripes to the edges of the scale band are geometrically expanded, respectively compressed. If, for example, the scale band is 10 mm wide, a maximum angle up to 60° can be achieved with a writing tool of 20 mm width. During the manufacturing of the scale band, the writing tool is therefore to be pivoted starting from the minimum inclination angle of 0° to the maximum inclination angle of 60° and then back to the minimum angle of 0°. The manufacturing of the both traces can therefore advantageously be achieved in one single working step. Furthermore, it is possible that a full modulation wavelength of the marker stripes is between the first position and the second position, since two information in shape of the locally present inclination angles of the marker stripe transitions are simultaneously present by the both marker detection sensors.

The method according to the invention for measuring the position of the first body to the second body comprises the steps: providing the measuring device according to the invention; capturing the amplitude of the signals of the marker detection sensors; determining the position of the bodies to each other within the first position and the second position by means of the inclination angles detected by the marker detection sensors.

It is furthermore preferred that for determining the position of the bodies to each other within the first position and the second position the gradients of inclination angles are considered.

In the following, a preferred embodiment of the measuring device according to the invention is explained on the basis of schematic drawings.

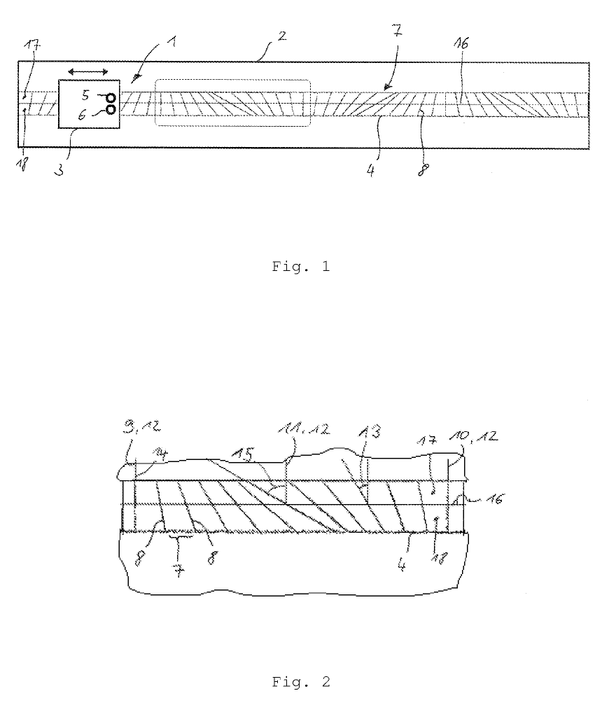

FIG. 1 shows a top view of the preferred embodiment of the measuring device according to the invention and

FIG. 2 a detail view of FIG. 1.

As it can be seen from FIGS. 1 and 2, a measurement device 1 is provided in order to measure the position of a first body 2 to a second body 3. The first body 2 is, for example, formed as a rail, whereas the second body 3 is, for example, formed as a slide. The second body 3 can be moved relatively to the first body 2, wherein the absolute position of the second body 3 to the first body 2 can be determined with the measuring device 1.

The measuring device 1 comprises a scale band 4 that is applied on the first body 2. It is conceivable that the scale band 4 lies as a separate band on the first body 2. The scale band 4 could also be directly formed on the surface of the first body 2. It is conceivable that the first body 2 is formed as a cylinder, wherein the scale band 4 is cyclically closed. Further, the second body 3 comprises a first marker detection sensor 5 and a second marker detection sensor 6, wherein the second body 3 is supposed to be moved relatively to the first body 2 such that the marker detection sensors 5, 6 are moved along the scale band 4. The marker detection sensors 5, 6 are magnetoresistive sensors or Hall-sensors.

The scale band 4 is made out of a ferromagnetic material with high energy density or a magnetically hard material. A magnetizing head that is aligned transverse to the scale band 4 was moved over the scale band 4 during the magnetizing of the scale band 4, wherein the magnetizing head was alternating pivoted around the transversal direction of the scale band 4. The scale band 4 was therefore provided with a multitude of marker stripes 7, wherein each marker stripe 7 is either formed by a north pole or a south pole. The marker stripes 7 are alternating magnetized with north and south poles, so that transitions 8 in the shape of pole transitions are formed from marker stripe to marker stripe. It would also conceivable that the scale band 4 is formed by a direct magnetization of the surface of the first body 2, wherein the first body 2 correspondingly comprises a material that can be magnetized.

A first position 9 is defined on the scale band 4 and a second position 10 is defined in the longitudinal distance of the scale band 4. A third position 11 is located in the centre between the first position 9 and the second position 10. The transversal direction 12 is defined in the plane, in which the scale band 4 is lying, normal to the scale band 4. Each of the transitions 8 has an inclination angle 13 to the transversal direction 12. One of the transitions 8 is located on the first position 9, which inclination angle 13 is 0°. Another of the transitions 8 is located on the second position 10, which inclination angle is also 0°. The transitions 8 that are arranged between the first position 9 and the second position 10 have inclination angles that are larger than the inclination angles of the transitions 8 in the first position 9 and the second position 10, so that the transitions 8 in the first position 9 and the second position 10 have a minimum angle 14 of 0°. A multitude of the transitions 8 is arranged between the first position 9 and the second position 10, wherein the inclination angles 13 of the transitions 8 increase from the first position 9 to the third position 11 and decreases again from the third position 11 to the second position 10. The transition 8, which inclination angle 13 is largest, is located on the third position 11, so that this inclination angle is a maximum angle 15. The maximum angle 15 is 60°.

The longitudinal distances between the transitions 8 are respectively equally large in the centre 16 of the scale band 4. Seen in FIGS. 1 and 2, a first trace 17 is defined above the centre 16 and a second trace 18 is defined below the centre. The upper halves of the transitions 8 are therefore in the first trace 17, whereas the lower halves of the transitions 8 are in the second trace 18. The marker detection sensors 5, 6 are arranged lying next to each other in transversal direction 12 on the second body 3, wherein the first marker detection sensor 5 is arranged immediately adjacent to the first trace 17 and perpendicular to the drawing plane of FIG. 1 above the scale band 4. The second marker detection sensor 6 is arranged in analogous manner immediately adjacent to second trace 18 perpendicular to the drawing plane of FIG. 1 above the scale band 4. During a relative movement of the second body 3 to the first body 2, which is indicated with an arrow in FIG. 2, the marker detection sensors 5, 6 are moved above the scale band 4, wherein the marker detection sensor 5 follows the first trace 17 and the second marker detection 6 follows the second trace 18.

If the marker detection sensors 5, 6 are arranged between the first position 9 and the second position 10, the marker detection sensors 5, 6 capture the inclination angle 13 of the corresponding transitions that are arranged immediately adjacent to the respective marker detection sensors 5, 6. The absolute position of the second body 3 can be unambiguously determined by means of the given distribution of the inclination angles 13 between the first position 9 and the second position 10 and by means of the inclination angles of the immediately adjacent transitions 8 detected by the marker detection sensors, respectively by means of the gradients of the inclination angles detected by the marker detection sensors.

Since the marker detection sensors 5, 6 are arranged seen in the transversal direction 12 in a row and seen in the longitudinal direction 12 of the scale band 4 arranged next to each other, both marker detection sensors 5, 6 can be moved to the first position 9 and to the second position, wherein all transitions 8 situated between the first position 9 and the second position 10 can be captured by the marker detection sensors 5, 6 and therefore each position of the second body 3 between the first position 9 and the second position 10 can be determined. For example protrusions of the scale band 4 above the first position 9, respectively the second position 10 do need to be provided.

### LIST OF REFERENCE SIGNS

1 measuring device
2 first body
3 second body
4 scale band
5 first marker detection sensor
6 second marker detection sensor
7 marker stripes
8 transitions
9 first position
10 second position
11 third position
12 transversal direction
13 inclination angle
14 minimum angle
15 maximum angle
16 centre of the scale band
17 first trace
18 second trace

1. Measuring device (1) for measuring the position of a first body (2) to a second body (3) being neighboured to the first body (2) and being movable relative to the first body (2), wherein the measuring device (1) comprises a scale band (4) that can be attached to the first body (2) and that comprises a marker, wherein the measuring device (1) comprises two marker detection sensors (5, 6) that can be attached to the second body (3), wherein the marker is formed by a pattern out of marker stripes (7), which transitions (8) from marker stripe (7) to marker stripe (7) between a first position (9) of the scale band (4) and a second position (10) being arranged in the longitudinal direction of the scale band (4) in a distance to the first position (9) are respectively arranged predetermined inclined to the transversal direction (12) of the scale band (4) in such a respective inclination angle (13) that each of the inclination angles (13) has a value that differs from the values of the other inclination angles, wherein the scale band (4) is divided in transversal direction into two traces (17, 18), wherein one of the marker detection sensors (5) is arranged neighboured to the first trace (17) for detecting the inclination angle (13) on a position of one halve of one of the marker stripe transitions (8) and the other of the marker detection sensors (6) is arranged neighboured to the second trace (18) for detecting the inclination angle (13) of another position of one of the marker stripe transitions (8) as well as the marker detection sensors (5, 6) are arranged seen in the transversal direction (12) of the scale band (4) next to each other between the first position (9) and the second position (10), so that the position of the first body (2) to the second body (3) can be determined within the first and the second position (9, 10) by detecting the inclination angles (13).

2. Measuring device according to claim 1, wherein the marker stripes (7) are formed in the shape of a trapezium.

3. Measuring device according to claim 1, wherein the marker stripes (7) are formed by colourings of the surface of the scale band (4) and the marker detection sensors (5, 6) are optical sensors or cameras.

4. Measuring device according to claim 3, wherein the marker stripes (7) form a bright-dark-stripe pattern.

5. Measuring device according to claim 1, wherein the marker stripes (7) are formed by permanent magnetic poles of the scale band (4) and the marker detection sensors (5, 6) are magnetic sensors.

6. Measuring device according to claim 5, wherein the magnetic sensors are magnetoresistive sensors or Hall-sensors.

7. Measuring device according to claim 1, wherein the marker stripe transitions (8) on the first and the second position (9, 10) respectively have a minimum angle (14) as their inclination angle as well as one of the marker stripe transitions (8) is arranged between the both positions on a third position (11) of the scale band (4), wherein this marker stripe transitions (8) is arranged inclined in a maximum angle (15) to the transversal direction (12) of the scale band (4), wherein the inclination angles of the marker stripes transitions (8) that are arranged between the first position (9) and the third position (11) and that are arranged between the second position (10) and the third position (11) increase in direction to the third position (11) monotonically from the minimum angle (14) to the maximum angle (15).

8. Measuring device according to claim 7, wherein the marker stripes (4) seen in the transverse direction (12) of the scale band (4) have respectively the same width in the centre (16) of the scale band (4).

9. Measuring device according to claim 7, wherein the minimum angle (14) is 0°.

10. Measuring device according to claim 7, wherein the maximum angle (15) is 90°, in particular 60°.

11. Measuring device according to claim 7, wherein the number of the marker stripe transitions (8) from one of the marker stripes to the neighboured marker stripes between the first position (9) and the third position (11) and the number of the marker stripe transitions (8) from one of the marker stripes to the neighboured marker stripe between the second position (10) and the third position (11) are equally high.

12. Measuring device according to claim 7, wherein the inclination angles (13) of the marker stripes that are arranged between the first position (9) and the third position (11) and that are arranged between the second position (10) and the third position (11) increase strictly monotonically in direction to the third position (11) from the minimum angle (14) to the maximum angle (15).

13. Method for measuring the position of a first body (2) to a second body (3) being neighboured to the first body (2) and being movable relative to the first body (2), with the steps:
providing a measuring device (1) according to claim 1 on the bodies (2, 3);
capturing the amplitude of the signals of the marker detection sensors (5, 6);
determining the position of the bodies (5, 6) to each other within the first position (9) and the second position (10) by means of the inclination angles (13) detected by the marker detection sensors (5, 6).

14. Method according to claim 13, wherein the gradients of inclination angles (13) are considered for determining the position of the bodies (2, 3) to each other within the first position (9) and the second position (10).

15. Measuring device according to claim 2, wherein the marker stripes (7) are formed by colourings of the surface of the scale band (4) and the marker detection sensors (5, 6) are optical sensors or cameras.

16. Measuring device according to claim 2, wherein the marker stripes (7) are formed by permanent magnetic poles of the scale band (4) and the marker detection sensors (5, 6) are magnetic sensors.

17. Measuring device according to claim 2, wherein the marker stripe transitions (8) on the first and the second position (9, 10) respectively have a minimum angle (14) as their inclination angle as well as one of the marker stripe transitions (8) is arranged between the both positions on a third position (11) of the scale band (4), wherein this marker stripe transitions (8) is arranged inclined in a maximum angle (15) to the transversal direction (12) of the scale band (4), wherein the inclination angles of the marker stripes transitions (8) that are arranged between the first position (9) and the third position (11) and that are arranged between the second position (10) and the third position (11) increase in direction to the third position (11) monotonically from the minimum angle (14) to the maximum angle (15).

18. Measuring device according to claim 7, wherein the maximum angle (15) is 90°, in particular 60°.

19. Measuring device according to claim 7, wherein the number of the marker stripe transitions (8) from one of the marker stripes to the neighboured marker stripes between the first position (9) and the third position (11) and the number of the marker stripe transitions (8) from one of the marker stripes to the neighboured marker stripe between the second position (10) and the third position (11) are equally high.

20. Measuring device according to claim 7, wherein the inclination angles (13) of the marker stripes that are arranged between the first position (9) and the third position (11) and that are arranged between the second position (10) and the third position (11) increase strictly monotonically in direction to the third position (11) from the minimum angle (14) to the maximum angle (15).
